(19) United States
(12) Patent Application Publication
(10) Pub. No.: US 2026/0079271 A1
(43) Pub. Date: Mar. 19, 2026

(54) AROMATIC EUTECTIC MIXTURES AND THEIR USE AS LIQUID SCINTILLATORS

(71) Applicants: COMMISSARIAT A L'ENERGIE ATOMIQUE ET AUX ENERGIES ALTERNATIVES, Paris (FR); CENTRE NATIONAL DE LA RECHERCHE SCIENTIFIQUE (CNRS), Paris (FR); Université Clermont Auvergne, Clermont Ferrand (FR)

(72) Inventors: Pauline Vergnory, Gif-sur-Yvette Cedex (FR); Guillaume Bertrand, Gif-sur-Yvette Cedex (FR); Jean-Michel Andanson, Clermont-Ferrand (FR)

(73) Assignees: COMMISSARIAT A L'ENERGIE ATOMIQUE ET AUX ENERGIES ALTERNATIVES, Paris (FR); CENTRE NATIONAL DE LA RECHERCHE SCIENTIFIQUE (CNRS), Paris (FR); Université Clermont Auvergne, Clermont Ferrand (FR)

(21) Appl. No.: 19/332,628

(22) Filed: Sep. 18, 2025

(30) Foreign Application Priority Data
Sep. 19, 2024 (FR) FR2409997

(51) Int. Cl. G01T 1/204

(52) U.S. Cl. CPC G01T 1/2042

(57) ABSTRACT

This disclosure concerns aromatic and polyaromatic eutectic mixtures and their use as liquid scintillators. The mixtures may include compounds including di-tert-butyl-benzenes, biphenyls and terphenyls, polycyclic aromatic hydrocarbons selected from naphthalenes, acenaphthenes, anthracenes and pyrenes, fluorenes and carbazoles, 2,5-Diphenyloxazoles, and compounds of formula (I).

### CROSS-REFERENCE TO RELATED APPLICATION

This application claims priority to FR 2409997, filed Sep. 19, 2024, the disclosure of which is hereby expressly incorporated by reference herein in its entirety.

### BACKGROUND

This disclosure concerns aromatic and polyaromatic eutectic mixtures and their use as liquid scintillators.

Based on the conversion of ionizing radiation into light radiation, the liquid scintillation is one of the oldest techniques for detecting and measuring radiation.

This method is currently one of the most frequently used techniques for measuring the activity of pure beta emitting radionuclides (for which radioactive decay is not accompanied by gamma radiation detectable by other techniques). It is also used to measure radionuclides that decay by electron capture or alpha emission. More specifically, the liquid scintillation is of major interest for measuring low-energy beta radiation.

The liquid scintillation activity measurement is based on the transformation of ionizing radiation emitted during the decay of a radioactive atom into detectable and quantifiable light radiation.

The liquid scintillation typically involves mixing an aliquot of the solution to be measured with a scintillating liquid, usually a liquid solution containing organic scintillators, to detect the radiation emitted by a radioactive source. When the ionising particles interact with the liquid, they excite the scintillator molecules which, when de-excited, emit light (photon). This light is then detected by a photomultiplier or photodetector, allowing the energy and intensity of the radiation to be quantified.

The role of this scintillating liquid is to transform the energy of the ionising radiation emitted by the disintegration of a radionuclide into quantifiable pulses of light. This liquid has one main component: an organic solvent.

The composition of the scintillating liquid must allow, on the one hand, (1) perfect miscibility between the matrix in which the radionuclide whose activity is to be measured is found and the solvent and, on the other hand, (2) an efficient transfer of the energy from the ionizing particle to the fluorescent molecules, to allow the emission of light photons that can be detected by photomultipliers.

The main component of the scintillating liquid, the solvent is generally made up of aromatic molecules. Its function is to absorb the energy of the ionizing radiation and propagate it to the fluorescent molecules. The solvent must be relatively chemically inert.

Historically, the molecules used were benzene and toluene, followed by xylene and pseudocumene, which are less toxic.

However, these solvents are highly flammable and tend to evaporate easily, making them difficult and risky to handle and store. All these organic solvents have fairly low flash points, typically <100° C. This represents a major risk for applications that use large volumes of these solvents, such as the liquid scintillation.

The sparkling liquids marketed since the 1980s use new-generation solvents: di-isopropylnaphthalene (DIN), phenylxylylethane (PXE) and dodecylbenzene. Although these solvents are less toxic and have a higher flash point, they are less chemically stable.

Compositions based on alkaline molecules or phosphonium salts have also been developed for the liquid scintillation. However, these two families of molecules are known to be less effective for scintillation than the commercial compounds.

Thus, although the liquid organic scintillators are valuable tools for radiation detection, the solvents used present significant challenges in terms of safety, stability, and performance.

The disclosure therefore aims to provide compositions that allow overcoming the aforementioned disadvantages.

One objective of the disclosure is to provide compositions that are not highly flammable, in particular having flash points >100° C., thereby reducing the aforementioned risks, while still being suitable for use in liquid scintillation.

Another objective of the disclosure is to provide such compositions, which are at least equivalent to, or even more effective than, the commercial scintillators.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

Thus, according to a first aspect, the disclosure relates to a composition consisting of, consisting essentially of, or comprising at least two compounds chosen from:
Di-tert-butyl-benzenes;
Biphenyls and terphenyls, optionally substituted by two groups independently selected from the linear or branched C₁ to C₆ alkyls;
Polycyclic aromatic hydrocarbons selected from naphthalenes, acenaphthenes, anthracenes and pyrenes, which are optionally substituted by two groups independently selected from linear or branched C₁ to C₆ alkyls;
Fluorenes and carbazoles, which are optionally substituted by two or four groups independently selected from linear or branched C₁ to C₆ alkyls;
2,5-Diphenyloxazoles, optionally substituted by two groups independently selected from linear or branched C₁ to C₆ alkyls;
The compounds of formula (I):

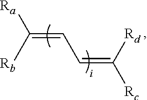

wherein:
i is equal to 0 or 1;
Rₐ, R_{b}, R_{c} and R_{d} are independently selected from H and phenyl, at least two of Rₐ, R_{b}, R_{c} and R_{d} being phenyl;
the compounds of formula (I) being optionally substituted, in particular on the phenyl groups, by two groups chosen independently from linear or branched C₁ to C₆ alkyls;
the composition not consisting of biphenyl and naphthalene.

Surprisingly, it has been demonstrated by the Inventors that these compounds have a melting point >60° C. individually, but once in a composition according to the disclosure, have a lower melting point, or even liquid at room temperature, within a purely aromatic or even polyaromatic eutectic.

And all these aromatics and even polyaromatic molecules can be used successfully in scintillation.

According to one embodiment, the composition according to the disclosure is eutectic.

According to one embodiment, the at least two compounds are in particular chosen from the following compounds:

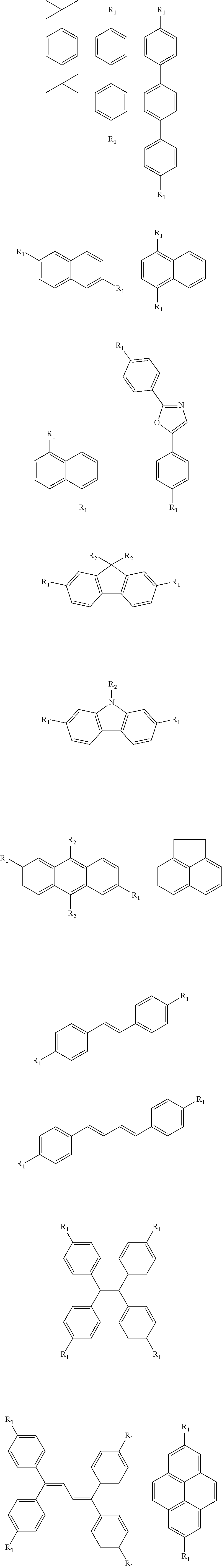

in which R₁ and R₂ are chosen independently of each other,
R₁ being selected from H and linear or branched C₁ to C₆ alkyls, and R₂ being selected from H and linear or branched C₁ to C₆ alkyls.

According to one embodiment, the composition of the disclosure is binary, tertiary, quaternary, quinary and so on, depending on the number of components.

According to one embodiment, the composition of the disclosure is binary, tertiary, quaternary or quinary.

According to one embodiment, the composition of the disclosure is:
binary, and the two compounds of the composition are present therein in an amount of 20 to 80 mol %, in particular in an amount of 40 to 60 mol %;
tertiary, and the three compounds of the composition are present therein in an amount of 10 to 55 mol %, in particular in an amount of 25 to 40 mol %;
quaternary, and the four compounds of the composition are present therein in an amount of 5 to 45 mol %, in particular in an amount of 22 to 40 mol % for three of them, and in an amount of 6 to 34 mol % for the last one; or
quinary, and the five compounds of the composition are present therein in an amount of 5 to 45 mol %.

According to one embodiment, the composition of the disclosure consists of, consists essentially of, or comprises the at least two compounds, and in addition at least one wavelength-shifter compound.

According to another aspect, the disclosure also relates to the use of a composition for the liquid scintillation, the composition consisting of, consists essentially of, or comprising at least two compounds chosen from:
Di-tert-butyl-benzenes;
Biphenyls and terphenyls, optionally substituted by two groups independently selected from the linear or branched C₁ to C₆ alkyls;
Polycyclic aromatic hydrocarbons selected from naphthalenes, acenaphthenes, anthracenes and pyrenes, which are optionally substituted by two groups independently selected from linear or branched C₁ to C₆ alkyls;
Fluorenes and carbazoles, which are optionally substituted by at least two groups independently selected from linear or branched C₁ to C₆ alkyls;
2,5-Diphenyloxazoles, optionally substituted by two groups independently selected from linear or branched C₁ to C₆ alkyls;
The compounds of formula (I):

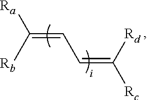

wherein:
i is equal to 0 or 1;
Rₐ, R_{b}, R_{c} and R_{d} are independently selected from H and phenyl, at least two of Rₐ, R_{b}, R_{c} and R_{d} being phenyl;
the compounds of formula (I) being optionally substituted, in particular on the phenyl groups, by two groups independently selected from linear or branched C₁ to C₆ alkyl.

The compositions of the disclosure are aromatic, or even polyaromatic, and can be used successfully in scintillation.

According to one embodiment, the use of the disclosure is a use of the composition as a liquid scintillator.

According to one embodiment, the composition consists of, consists essentially of, or comprises the at least two compounds, and in addition at least one wavelength-shifter compound.

According to one embodiment, the composition is solvent-free, the solvent being different from all the previously defined compounds and mixtures thereof.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 shows the pulse area spectra of the eutectics T_{A}, Q_{A}, Q_{B} and Q_{C} from Example 1 under irradiation with a ¹³⁷Cs source (Example 2).

FIG. 2 shows the pulse area spectra of the eutectics T_{A}, Q_{A}, Q_{B} and Q_{C} with POPOP from Example 1 under irradiation with a ¹³⁷Cs source (Example 2).

FIG. 3 is a comparison, according to example 3, of the area spectrum between a commercial reference liquid scintillator not used in the disclosure (BC501A) and two scintillating liquid eutectics T_{A} and Q_{A} from Example 1, in the presence of POPOP (T_{A}+POPOP and Q_{A}+POPOP from Example 2).

### DETAILED DESCRIPTION

As understood here, the value ranges in the form of “x-y” or “from x to y” or “between x and y” include the x and y bounds as well as the integers between these bounds, and the positive real numbers between these bounds and/or integers. For example, “1-5”, or “from 1 to 5” or “between 1 and 5” refer to the integers 1, 2, 3, 4 and 5. The preferred embodiments include each individual integer in the value range, as well as any sub-combination of those integers. For example, the preferred values for “1-5” may comprise the integers 1, 2, 3, 4, 5, 1-2, 1-3, 1-4, 1-5, 2-3, 2-4, 2-5, etc.

As used herein, the term “alkyl” designates a linear or branched chain alkyl group having the number of carbon atoms indicated before the term, in particular 1 to 4 carbon atoms, such as methyl, ethyl, propyl, isopropyl, butyl, isobutyl, sec-butyl, tert-butyl, etc. Thus, an expression such as “C₁ to C₄ alkyl” designates an alkyl radical containing from 1 to 4 carbon atoms.

By “the composition does not consist of biphenyl and naphthalene” is meant in particular that the composition is not a mixture consisting of unsubstituted biphenyl and unsubstituted naphthalene. In particular, the composition not consisting of biphenyl, optionally substituted with two groups independently selected from linear or branched C₁ to C₆ alkyl, and naphthalene, optionally substituted with two groups independently selected from linear or branched C₁ to C₆ alkyl.

The compositions of the disclosure are eutectics. By “eutectic” we mean in particular a mixture of two or more substances which has a lower melting temperature than that of each of the individual substances.

The di-tert-butyl-benzene is in particular 1,4-di-tert-butyl-benzene.

The biphenyls and terphenyls are in particular biphenyl and para-terphenyl.

The optionally substituted biphenyls are in particular of the following formula:

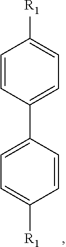

wherein R₁ is selected from H and linear or branched C₁ to C₆ alkyl.

The optionally substituted terphenyls are in particular of the following formula:

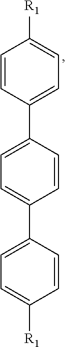

wherein R₁ is selected from H and linear or branched C₁ to C₆ alkyl.

The naphthalenes are optionally of one of the following formulae:

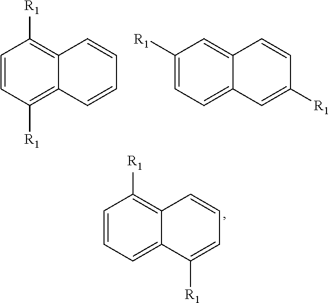

wherein R₁ is selected from H and linear or branched C₁ to C₆ alkyl.

The acenaphthene in particular is unsubstituted.

The optionally substituted anthracenes are in particular of the following formula:

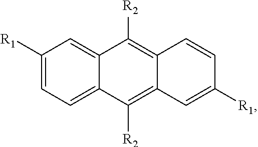

wherein R₁ is selected from H and linear or branched C₁ to C₆ alkyl, and R₂ is selected from H and linear or branched C₁ to C₆ alkyl.

The optional pyrenes are in particular of the following formula:

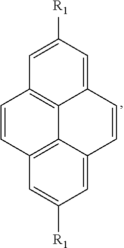

wherein R₁ is selected from H and linear or branched C₁ to C₆ alkyl.

The 2,5-diphenyloxazoles optionally are in particular of the following formula:

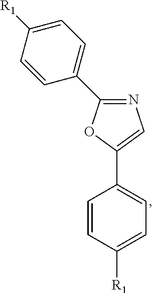

wherein R₁ is selected from H and linear or branched C₁ to C₆ alkyl.

The optionally substituted fluorenes are in particular of the following formula:

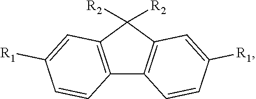

wherein R₁ is selected from H and linear or branched C₁ to C₆ alkyl, and R₂ is selected from H and linear or branched C₁ to C₆ alkyl.

The optionally substituted carbazoles are in particular of the following formula:

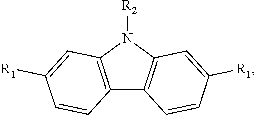

wherein R₁ is selected from H and linear or branched C₁ to C₆ alkyl, and R₂ is selected from H and linear or branched C₁ to C₆ alkyl.

The compounds of formula (I) are in particular chosen from 1,2-diphenylethenes, 1,1,2,2-tetraphenylethenes, 1,2-diphenylbutadienes, 1,1,4,4-tetraphenylbutadienes, optionally substituted, in particular on the phenyl groups, by two groups chosen independently from linear or branched C₁ to C₆ alkyls.

The 1,1,2,2-diphenylethenes are optionally of the following formula:

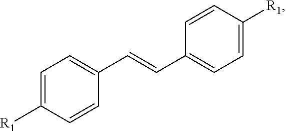

wherein R₁ is selected from H and linear or branched C₁ to C₆ alkyl.

The 1,1,2,2-tetraphenylethenes are optionally of the following formula:

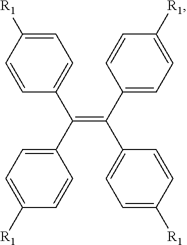

wherein R₁ is selected from H and linear or branched C₁ to C₆ alkyl.

The 1,2-diphenylbutadienes optionally have the following formula:

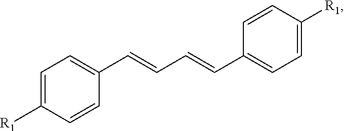

wherein R₁ is selected from H and linear or branched C₁ to C₆ alkyl.

The optional 1,1,4,4-tetraphenylbutadienes are in particular of the following formula:

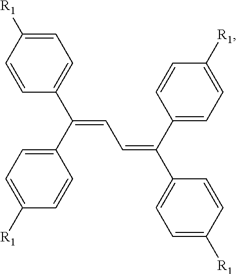

wherein R₁ is selected from H and linear or branched C₁ to C₆ alkyl.

The composition according to the disclosure can be a composition in which the at least two compounds are of the same formula as defined above, differing only in the meaning of the R₁ and/or R₂ group.

According to a particular embodiment, the composition according to the disclosure consists of at least two compounds as defined above.

The composition, in particular the eutectic, according to the disclosure can be binary (two-component), tertiary (three-component), quaternary (four-component), quinary (five-component) and so on.

According to one embodiment, the composition of the disclosure is tertiary, quaternary or quinary. This is likely to enable compositions with a lower melting temperature, for example much lower than ambient temperature, to be obtained if desired.

According to a particular embodiment, the composition consists of, consists essentially of, or comprises:
a biphenyl, optionally substituted by two groups independently selected from linear or branched C₁ to C₆ alkyls, in particular biphenyl; and
a 2,5-diphenyloxazole, optionally substituted with two groups independently selected from linear or branched C₁ to C₆ alkyls, in particular 2,5-diphenyloxazole.

According to a particular embodiment, the composition consists of, consists essentially of, or comprises:
a biphenyl, optionally substituted by two groups independently selected from linear or branched C₁ to C₆ alkyl, in particular biphenyl;
a 2,5-diphenyloxazole, optionally substituted by two groups independently selected from linear or branched C₁ to C₆ alkyls, in particular 2,5-diphenyloxazole; and
a carbazole, optionally substituted with two groups independently selected from linear or branched C₁ to C₆ alkyls, in particular 9-ethylcarbazole.

According to a particular embodiment, the composition consists of, consists essentially of, or comprises:
a biphenyl, optionally substituted by two groups independently selected from linear or branched C₁ to C₆ alkyl, in particular biphenyl;
a 2,5-diphenyloxazole, optionally substituted by two groups independently selected from linear or branched C₁ to C₆ alkyls, in particular 2,5-diphenyloxazole;
a carbazole, optionally substituted by two groups independently selected from linear or branched C₁ to C₆ alkyls, in particular 9-ethylcarbazole; and
a diterbutylbenzene, in particular 1,4-Diterbutylbenzene, a second biphenyl, optionally substituted with two groups independently selected from C₁ to C₆ different from the first, in particular diterbutylbiphenyl, and/or a fluorene, in particular diterbutylfluorene.

The composition of the disclosure may additionally comprise at least one wavelength-shifter compound.

According to a particular embodiment, the at least one wavelength-shifter compound is chosen from the following compounds, and mixtures thereof: POPOP, 9-10 DPA, Bis-MSB, Coumarine-6.

These compounds have the following formula:

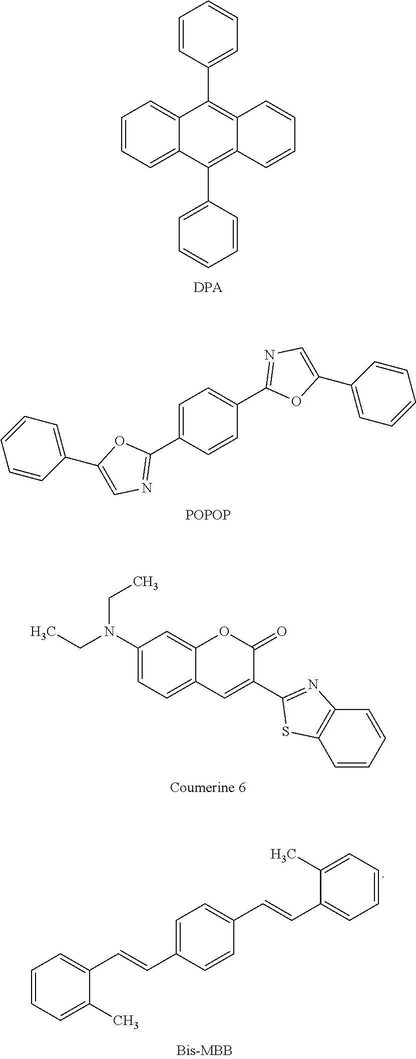

According to a particular embodiment, the at least one wavelength-shifter compound is present in the composition in an amount of 0.01% to 0.3% by weight relative to the total weight of the composition, in particular 0.03% to 0.1% by weight.

According to another aspect, the disclosure also relates to a composition consisting of, consists essentially of, or comprising at least two compounds chosen from:
Di-tert-butyl-benzenes;
Biphenyls and terphenyls, optionally substituted by two groups independently selected from the linear or branched C₁ to C₆ alkyls;
Polycyclic aromatic hydrocarbons selected from naphthalenes, acenaphthenes, anthracenes and pyrenes, which are optionally substituted by two groups independently selected from linear or branched C₁ to C₆ alkyls;
Fluorenes and carbazoles, which are optionally substituted by two or four groups independently selected from linear or branched C₁ to C₆ alkyls;
2,5-Diphenyloxazoles, optionally substituted by two groups independently selected from linear or branched C₁ to C₆ alkyls;
The compounds of formula (I):

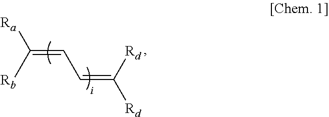

wherein:
i is equal to 0 or 1;
Rₐ, R_{b}, R_{c} and R_{d} are independently selected from H and phenyl, at least two of Rₐ, R_{b}, R_{c} and R_{d} being phenyl;
the compounds of formula (I) being optionally substituted, in particular on the phenyl groups, by two groups chosen independently from linear or branched C₁ to C₆ alkyls;
and in addition at least one wavelength-shifter compound.

The composition of the disclosure may also additionally comprise at least one secondary fluorophore (or wavelength-shifter).

These secondary fluorophores are well known to those skilled in the art.

According to a particular embodiment, the at least one secondary fluorophore is chosen from POPOP, BisMSB, 9-10 DPA and Coumarin 6.

According to a particular embodiment, the at least one secondary fluorophore is present in the composition at a level of 0.01 to 0.3% by mass.

According to another aspect, the disclosure also relates to the use of a composition as described above for liquid scintillation, in particular as a liquid scintillator.

All the embodiments previously defined in relation to the composition of the disclosure also apply here, alone or in combination.

According to a particular embodiment, the composition does not consist of biphenyl and naphthalene. In fact, their binary eutectic may not have a low enough melting point depending on the intended use.

### EXAMPLES

### Example 1: Preparation of Compositions According to the Disclosure

The binary mixtures B_{A}, ternary mixtures T_{A}, and quaternary mixtures Q_{A}Q_{B} and Q_{C} were prepared and characterized as follows.

The melting temperature of the mixtures was determined by Differential Scanning Calorimetry (DSC).

| Molecule | Molar proportion | Tₘₑₗₜ (° C.) |
|---|---|---|
| Biphenyl | 44% | 69 |
| Diphenyleoxazole (PPO) | 56% | 70 |
| Eutectic | | T_{eutectic} (° C.) |
| B_{A} | | 39 |
| Molecule | Molar proportion | Tₘₑₗₜ |
| Biphenyl | 35.0% | 69 |
| 9-ethylcarbazole | 37.5% | 70 |
| Diphenyleoxazole (PPO) | 27.5% | 70 |
| Eutectic | | T_{eutectic} (° C.) |
| T_{A} | | 19 |
| Molecule | Molar proportion | Tₘₑₗₜ |
| Biphenyl | 31.6% | 69 |
| 9-ethylcarbazole | 33.7% | 70 |
| Diphenyleoxazole (PPO) | 24.8% | 70 |
| Diterbutylbenzene (DTBB) | 9.9% | 77 |
| Eutectic | | T_{eutectic} (° C.) |
| Q_{A} | | 16 |
| Molecule | Molar proportion | Tₘₑₗₜ |
| Biphenyl | 32.5% | 69 |
| 9-ethylcarbazole | 34.7% | 70 |
| Diphenyleoxazole (PPO) | 25.6% | 70 |
| Diterbutybiphenyl (DTBP) | 7.3% | 127 |
| Eutectic | | T_{eutectic} (° C.) |
| Q_{B} | | 16 |
| Molecule | Molar proportion | Tₘₑₗₜ |
| Biphenyl | 32.6% | 69 |
| 9-ethylcarbazole | 34.8% | 70 |
| Diphenyleoxazole (PPO) | 25.6% | 70 |
| Diterbutylfluorene (DTBF) | 7.0% | 123 |
| Eutectic | | T_{eutectic} (° C.) |
| Q_{C} | | 15 |

### Example 2: Use of Compositions According to the Disclosure as Liquid Scintillators

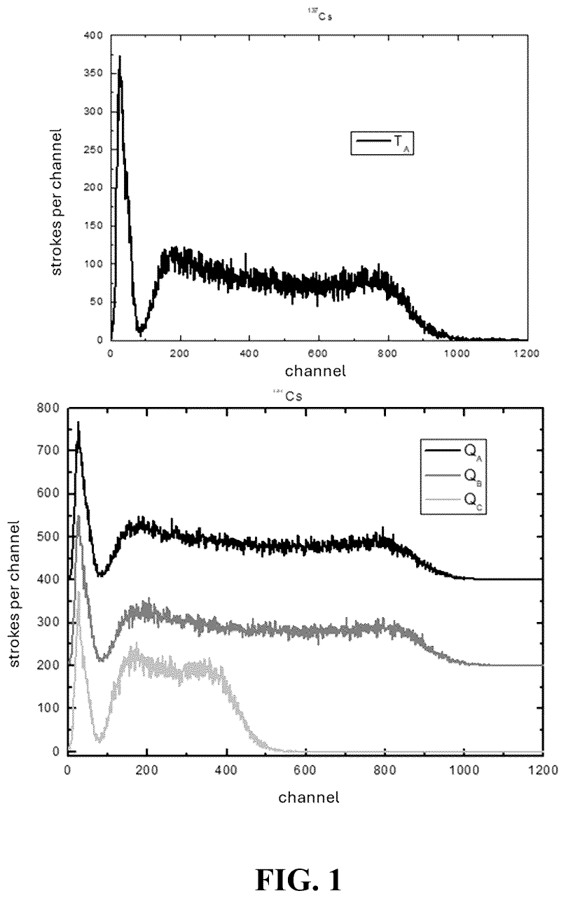

The mixtures in Example 1 were used as liquid scintillators. The mixtures T_{A}, QA, Q_{B}, and Q_{C} were in particular exposed as follows:
The area spectra shown in this example (FIG. 1) were produced by placing 10 g of the targeted eutectic mixture in a glass vial. The vial is then coated with a reflective material (PTFE strip) on all but one side. The free face is then brought into contact with a photomultiplier connected to standard scintillation measurement electronics.

FIG. 1 shows that the mixtures studied are all used successfully as liquid scintillators.

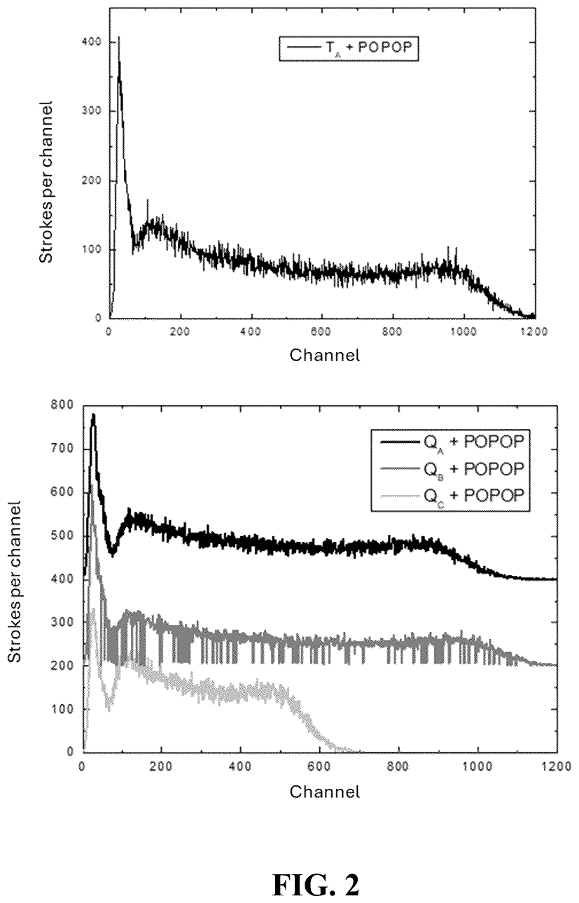

Mixtures of T_{A}+POPOP, QA+POPOP, Q_{B}+POPOP, et Q_{C}+POPOP have also been successfully studied (FIG. 2).

### Example 3: Comparison of the Compositions According to the Disclosure as Liquid Scintillators with a Commercial Reference not Used in the Disclosure

The mixtures T_{A}+POPOP et Q_{A}+POPOP of example 2 were compared as liquid scintillators with a commercial reference not included in the disclosure (BC501A). The mixtures T_{A}, Q_{A}, Q_{B}, and Q_{C} were in particular exposed as follows:
The area spectra were carried out as before.

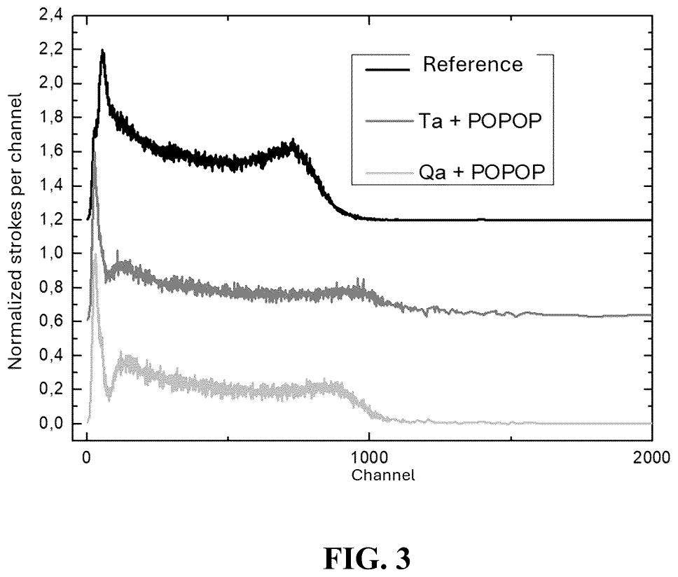

FIG. 3 shows that the compositions of the disclosure are at least equivalent, if not more effective, than the commercial scintillator.

In the detailed description herein, references to “one embodiment”, “an embodiment”, “an example embodiment”, “one or more embodiments”, “some embodiments”, etc., indicate that the embodiment or embodiments described may include a particular feature, structure, or characteristic, but every embodiment may not necessarily include the particular feature, structure, or characteristic. Moreover, such phrases are not necessarily referring to the same embodiment or embodiments. In addition, when a particular feature, structure, or characteristic is described in connection with an embodiment or embodiments, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments. Thus, it will be appreciated that embodiments of the present disclosure may employ any combination of features described herein. All such combinations or sub-combinations of features are within the scope of the present disclosure.

Throughout this specification, terms of art may be used. These terms are to take on their ordinary meaning in the art from which they come, unless specifically defined herein or the context of their use would clearly suggest otherwise.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

The embodiments of the invention in which an exclusive property or privilege is claimed are defined as follows:

1. A composition comprising two or more compounds chosen from:
Di-tert-butyl-benzenes;
Biphenyls and terphenyls, optionally substituted by two groups independently selected from the linear or branched C₁ to C₆ alkyls;
Polycyclic aromatic hydrocarbons selected from naphthalenes, acenaphthenes, anthracenes and pyrenes, which are optionally substituted by two groups independently selected from linear or branched C₁ to C₆ alkyls;
Fluorenes and carbazoles, which are optionally substituted by two or four groups independently selected from linear or branched C₁ to C₆ alkyls;
2,5-Diphenyloxazoles, optionally substituted by two groups independently selected from linear or branched C₁ to C₆ alkyls; and
Compounds of formula (I): 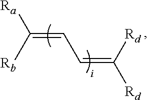
wherein:
i is equal to 0 or 1;
Rₐ, R_{b}, R_{c} and R_{d} are independently selected from H and phenyl, at least two of Rₐ, R_{b}, R_{c} and R_{d} being phenyl; and
the compounds of formula (I) being optionally substituted by two groups chosen independently from linear or branched C₁ to C₆ alkyls;
the composition not consisting of biphenyl and naphthalene.

2. The composition according to claim 1, which is eutectic.

3. The composition according to claim 1, wherein the at least two compounds are chosen from the following compounds: 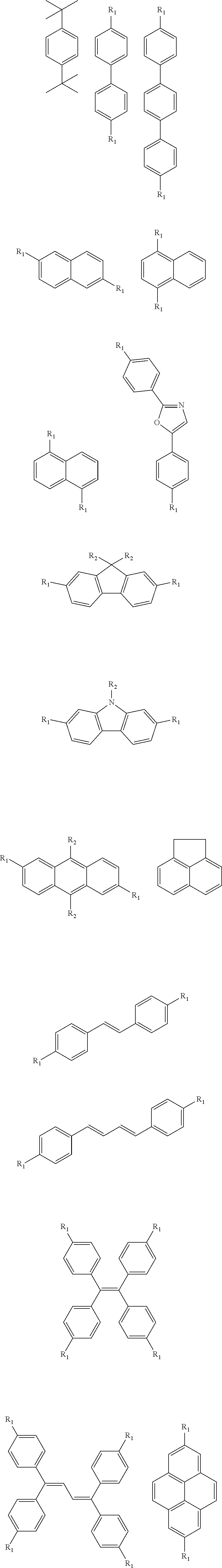
wherein R₁ and R₂ are chosen independently of each other,
R₁ being selected from H and linear or branched C₁ to C₆ alkyls, and R₂ being selected from H and linear or branched C₁ to C₆ alkyls.

4. The composition according to claim 1, which is binary, tertiary, quaternary or quinary.

5. The composition according to claim 1, which is:
binary, and the two compounds of the composition are present therein in an amount of 20 to 80 mol %;
tertiary, and the three compounds of the composition are present therein in an amount of 10 to 55 mol %;
quaternary, and the four compounds of the composition are present therein in an amount of 5 to 45 mol %; or
quinary, and the five compounds of the composition are present therein in an amount of 5 to 45 mol %.

6. The composition according to claim 1, further comprising at least one wavelength-shifter compound.

7. A method of use of a composition for liquid scintillation, the composition comprising at least two compounds selected from:
Di-tert-butyl-benzenes;
Biphenyls and terphenyls, optionally substituted by two groups independently selected from the linear or branched C₁ to C₆ alkyls;
Polycyclic aromatic hydrocarbons selected from naphthalenes, acenaphthenes, anthracenes and pyrenes, which are optionally substituted by two groups independently selected from linear or branched C₁ to C₆ alkyls;
Fluorenes and carbazoles, which are optionally substituted by at least two groups independently selected from linear or branched C₁ to C₆ alkyls;
2,5-Diphenyloxazoles, optionally substituted by two groups independently selected from linear or branched C₁ to C₆ alkyls; and
Compounds of formula (I): 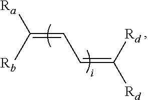
wherein:
i is equal to 0 or 1;
Rₐ, R_{b}, R_{c} and R_{d} are independently selected from H and phenyl, at least two of Rₐ, R_{b}, R_{c} and R_{d} being phenyl; and
the compounds of formula (I) being optionally substituted by two groups independently selected from linear or branched C₁ to C₆ alkyls.

8. The method of use according to claim 7 of the composition as a liquid scintillator.

9. The method of use according to claim 7, wherein the composition further comprises at least one wavelength-shifter compound.

10. The method of use according to claim 7, wherein the composition is solvent-free of a solvent, the solvent being a compound different from any of the compounds defined in claim 7, or mixtures thereof.

11. The composition of claim 1, wherein the compounds of formula (I) are optionally substituted on the phenyl groups by two groups chosen independently from linear or branched C₁ to C₆ alkyls.

12. The composition of claim 5, wherein:
when the composition is binary, the two compounds of the composition are present therein in an amount of 40 to 60 mol %;
when the composition is tertiary, the three compounds of the composition are present therein in an amount of 25 to 40 mol %;
when the composition is quaternary, the four compounds of the composition are present therein in an amount of 22 to 40 mol % for three of the four compounds, and in an amount of 6 to 34 mol % for the fourth of the four compounds.

13. The method of use of claim 7, wherein the compounds of formula (I) are optionally substituted on the phenyl groups by two groups independently selected from linear or branched C1 to C6 alkyls.
